(19) United States
(12) Patent Application Publication
(10) Pub. No.: US 2016/0150369 A1
(43) Pub. Date: May 26, 2016

(54) ASSET MANAGEMENT SYSTEM FOR OUTDOOR LUMINAIRES

(71) Applicant: Express Imaging Systems, LLC, Renton, WA (US)

(72) Inventor: William G. Reed, Seattle, WA (US)

(21) Appl. No.: 14/869,501

(22) Filed: Sep. 29, 2015

Related U.S. Application Data
(60) Provisional application No. 62/082,463, filed on Nov. 20, 2014.

(51) Int. Cl. H04W 4/02; H04L 12/26; H04W 4/00

(52) U.S. Cl. CPC H04W 4/021; H04W 4/008; H04L 43/065

(57) ABSTRACT

Systems, methods and articles for providing automatic collection of asset management data of outdoor illumination systems. A central asset management system organizes the collected data into electronic reports (e.g., spreadsheets, maps) presentable to a user. The asset management data may include, for example, identification information, location information, installation date, installation cost, installation details, type of luminaire, maintenance activities, specifications, purchase date, cost, expected lifetime, warranty information, service contracts, service history, spare parts, comments, or anything other information that may be useful to users (e.g., management, purchasers, installers, maintenance workers). A smart appliance with location determination capabilities, such as a global positioning system (GPS) receiver, provides location information to a luminaire when the smart appliance is positioned proximate a luminaire. The luminaires in the illumination system send location information and identification information to the central asset management system over a wired and/or wireless data communications channel.

### BACKGROUND

1. Technical Field

The present disclosure relates to illumination, and more particularly to management of a plurality of illumination devices and systems.

2. Description of the Related Art

Luminaires enjoy widespread use in a variety of industrial, commercial, and municipal applications. Such applications can include general or area lighting of workspaces, roadways, parking lots, and the like. Multiple luminaires are typically arranged in patterns and positioned at intervals sufficient to provide a minimum overall level of illumination across the area of interest. For example, luminaires may be spaced at intervals along a driveway in a multilevel parking garage to provide an overall level of illumination that permits safe ingress and egress by pedestrians as well as permits safe operation of motor vehicles within the parking garage. In a similar manner, luminaires may be spaced at intervals throughout a commercial center parking lot to promote safe operation of motor vehicles, permit safe ingress and egress by customers, and foster a sense of safety and well-being for business patrons within the commercial center. Similarly, a number of luminaires may be spaced along a roadway to provide a level of illumination permitting safe operation of motor vehicles on the roadway and, where applicable, safe passage of pedestrians on sidewalks adjoining the roadway.

To simplify power distribution and control wiring, such luminaires may be organized into groups or similar hierarchical power and control structures. For example, multiple luminaires along a roadway may be grouped together on a common power circuit that is controlled using a single, centralized controller to collectively adjust the luminous output of all of the luminaires in the group. In another instance, multiple luminaires within a parking garage may be controlled using a single photocell mounted on the exterior of the parking garage. Such installations may however compromise operational flexibility for ease of installation and simplicity of operation.

Energy conservation has become of ever-increasing importance. Efficient use of energy can result in a variety of benefits, including financial benefits such as cost savings and environmental benefits such as preservation of natural resources and reduction in “green house” (e.g., CO₂) gas emissions.

Residential, commercial, and street lighting which illuminate interior and exterior spaces consume a significant amount of energy. Conventional lighting devices or luminaires exist in a broad range of designs, suitable for various uses. Lighting devices employ a variety of conventional light sources, for example incandescent lamps, fluorescent lamps such as high-intensity discharge (HID) lamps (e.g., mercury vapor lamps, high-pressure sodium lamps, metal halide lamps).

There appear to be at least two primary approaches to reducing energy consumption associated with lighting systems. One approach employs higher efficiency light sources. The other approach selectively provides light only when needed.

Use of higher efficiency light sources may, for instance, include replacing incandescent lamps with fluorescent lamps or even with solid-state light sources (e.g., light emitting diodes (LEDs), organic LEDs (OLEDs), polymer LEDs (PLEDs)) to increase energy efficiency. In some instances, these higher efficiency light sources may present a number of problems. For example, fluorescent light sources may take a relatively long time after being turned ON to achieve their full rated level of output light or illumination. Such light sources also typically have a high energy consumption during warm-up. Many higher efficiency light sources emit light with a low color rendering index (CRI). For reference, sunlight has a CRI of 100 and represents “ideal light” which contains a continuous spectrum of visible radiation. Low CRI light is less pleasing to the human eye. Surfaces illuminated with low CRI light may not be perceived in their “true” color. Low CRI light makes it more difficult to discern details, often requiring a higher level of output light or illumination to discern details that would otherwise be discernable in high CRI light. Further, higher efficiency light sources may require additional circuitry (e.g., ballasts) and/or thermal management techniques (e.g., passive or active cooling).

Asset management of outdoor luminaires is an expensive endeavor for electric power providers and utilities. Manual entry of the location, identifier (e.g., serial number), installation date, type of luminaire, and other information is laborious, costly and error prone. Often, electric power providers find the expense of tracking and managing luminaires too great and therefore do not have asset management records for outdoor luminaires.

### BRIEF SUMMARY

A method of operation for a luminaire to permit management thereof by an asset management system located remote from the luminaire may be summarized as including storing luminaire identification information in at least one nontransitory processor-readable storage medium of the luminaire, the luminaire identification information uniquely identifies the luminaire; receiving, by at least one luminaire transceiver of the luminaire, mobile location provider system (MLPS) location information from an MLPS over at least one data communications channel, the MLPS location information indicative of a geographical location of the MLPS when the MLPS is positioned proximate the luminaire; storing the received MLPS location information in at least one nontransitory processor-readable storage medium of the luminaire as luminaire location information for the luminaire, the luminaire location information indicative of a geographical location of the luminaire; and sending, by at least one luminaire transceiver of the luminaire operatively coupled to the at least one data communications channel, the luminaire location information and the luminaire identification information to the asset management system over the at least one data communications channel. Receiving MLPS location information from an MLPS over at least one data communications channel may include receiving MLPS location information from an MLPS over at least one data communications channel, the MLPS location information indicative of a geographical location of the MLPS when the MLPS is positioned within 50 feet of the luminaire. Receiving MLPS location information from an MLPS over the at least one data communications channel may include receiving MLPS location information from an MLPS by the at least one luminaire transceiver over at least one of a Bluetooth®, WiFi®, near field communication (NFC), ANT®, or IEEE 802.15 channel. Receiving MLPS location information from an MLPS over the at least one data communications channel may include receiving MLPS location information by the at least one luminaire transceiver over at least one of a short-range wireless channel or a wired communications channel. Sending the luminaire location information and the luminaire identification information to the asset management system over the at least one data communications channel may include sending the luminaire location information and the luminaire identification information to the asset management system through at least one wireless communications channel. Sending the luminaire location information and the luminaire identification information to the asset management system over the at least one data communications channel may include sending the luminaire location information and the luminaire identification information to the asset management system through at least one power-line power distribution system.

The method may further include receiving, by at least one luminaire transceiver of the luminaire, the luminaire identification information from an MLPS over the at least one data communications channel. Receiving the luminaire identification information from an MLPS over the at least one data communications channel may include receiving the luminaire identification information by the at least one luminaire transceiver over at least one of a Bluetooth®, WiFi®, near field communication (NFC), ANT®, or IEEE 802.15 channel. Receiving the luminaire identification information from an MLPS over the at least one data communications channel may include receiving the luminaire identification information by at least one of a short-range wireless channel or a wired communications channel.

A luminaire may be summarized as including at least one luminaire processor; at least one luminaire transceiver operatively coupled to the at least one luminaire processor and to at least one data communications channel; and at least one luminaire nontransitory processor-readable storage medium operatively coupled to the at least one luminaire processor and which stores luminaire identification information which uniquely identifies the luminaire, the at least one luminaire nontransitory processor-readable storage medium further storing at least one of data or instructions which, when executed by the at least one luminaire processor, cause the at least one luminaire processor to: receive, via the at least one luminaire transceiver, mobile location provider system (MLPS) location information from an MLPS over the at least one data communications channel, the MLPS location information indicative of a geographical location of the MLPS when the MLPS is positioned proximate the luminaire; store the received MLPS location information in the at least one nontransitory processor-readable storage medium as luminaire location information for the luminaire, the luminaire location information indicative of a geographical location of the luminaire; and send, via the at least one luminaire transceiver, the luminaire identification information and the luminaire location information to an asset management system over the at least one data communications channel. The at least one luminaire processor may receive MLPS location information from an MLPS, the MLPS location information indicative of a geographical location of the MLPS when the MLPS is positioned within 50 feet of the luminaire. The at least one luminaire transceiver may receive the MLPS location information from the MLPS over at least one of a Bluetooth®, WiFi®, near field communication (NFC), ANT®, or IEEE 802.15 channel. The at least one luminaire transceiver may receive the MLPS location information from the MLPS over at least one of a short-range wireless channel or a wired communications channel. The at least one luminaire transceiver may send the luminaire location information to the asset management system through at least one wireless communications channel. The at least one luminaire transceiver may send the luminaire location information to the asset management system through at least one power-line power distribution system. The at least one luminaire processor may receive, via the at least one luminaire transceiver, the luminaire identification information from an MLPS over the at least one data communications channel. The at least one luminaire transceiver may receive the luminaire identification information from an MLPS over at least one of a Bluetooth®, WiFi®, near field communication (NFC), ANT®, or IEEE 802.15 channel. The at least one luminaire transceiver may receive the luminaire identification information from an MLPS over at least one of a short-range wireless channel or a wired communications channel.

A method of operation for a processor-based system to manage a plurality of remotely located luminaires may be summarized as including receiving, by at least one asset management processor, luminaire information from a plurality of luminaires over at least one data communications channel, wherein, for each of the luminaires, the luminaire information includes at least luminaire identification information that uniquely identifies the luminaire and luminaire location information that identifies a geographical location of the luminaire, the luminaire location information received by the luminaire over at least one data communications channel from a mobile location provider system (MLPS) as MLPS location information for the MLPS, the MLPS location information indicative of a geographical location of the MLPS when the MLPS is positioned proximate the luminaire; storing, by the at least one asset management processor, the received luminaire information in a nontransitory processor-readable storage medium; autonomously generating, by the at least one asset management processor, an electronic report based at least in part on the received luminaire information; and causing, by the at least one asset management processor, a user interface of a processor-based device to present the electronic report to a user. Autonomously generating an electronic report may include autonomously generating an electronic report that includes a map of the plurality of luminaires. Autonomously generating an electronic report may include autonomously generating a spreadsheet that includes the luminaire identification information and the luminaire location information for each of the plurality of luminaires. Causing, by the at least one asset management processor, a user interface of a processor-based device to present the electronic report to a user may include sending the electronic report to a processor-based device associated with the user over the at least one data communications channel. Receiving luminaire information from a plurality of luminaires over at least one data communications channel may include receiving luminaire information from the plurality of luminaires through at least one wireless communications channel. Receiving luminaire information from a plurality of luminaires over at least one data communications channel may include receiving luminaire information from the plurality of luminaires through at least one power-line power distribution system. Receiving luminaire information from the plurality of luminaires through at least one power-line power distribution system may include decoding the luminaire information from a power line of the power-line power distribution system.

A luminaire management system may be summarized as including at least one asset management system comprising: at least one asset management processor; at least one asset management system transceiver operatively coupled to the at least one asset management processor and a data communications channel; and at least one nontransitory processor-readable storage medium operatively coupled to the at least one asset management processor and storing at least one of data or instructions which, when executed by the at least one asset management processor, cause the at least one asset management processor to: receive luminaire information from a plurality of luminaires over the at least one data communications channel, wherein, for each of the luminaires, the luminaire information includes at least luminaire identification information that uniquely identifies the luminaire and luminaire location information that identifies a geographical location of the luminaire, the luminaire location information received by the luminaire over at least one data communications channel from a mobile location provider system (MLPS) as MLPS location information for the MLPS, the MLPS location information indicative of a geographical location of the MLPS when the MLPS is positioned proximate the luminaire; store the received luminaire information in the at least one nontransitory processor-readable storage medium; autonomously generate an electronic report based at least in part on the received luminaire information; and cause a user interface of a processor-based device to present the electronic report to a user. The at least one asset management processor may autonomously generate an electronic report that includes a map of the plurality of luminaires. The at least one asset management processor may autonomously generate a spreadsheet that includes the luminaire identification information and the luminaire location information for each of the plurality of luminaires. The at least one asset management processor may send the electronic report to a processor-based device associated with the user over the at least one data communications channel. The at least one data communications channel may include at least one wireless communications channel. The at least one data communications channel may include at least one power-line power distribution system.

A method to provide a luminaire with luminaire information may be summarized as including positioning a mobile location provider system (MLPS) proximate the luminaire, the MLPS storing MLPS location information on a nontransitory processor-readable storage medium of the MLPS, the MLPS location information indicative of a geographical location of the MLPS when the MLPS is positioned proximate the luminaire; and sending, by the MLPS, the MLPS location information to the luminaire over at least one data communications channel for storage as luminaire location information for the luminaire on a nontransitory processor-readable storage medium of the luminaire, the luminaire location information indicative of a geographical location of the luminaire. The luminaire may be one luminaire in an illumination system comprising a plurality of luminaires, and positioning an MLPS proximate the luminaire may include positioning an MLPS a distance from the luminaire less than distances from respective other ones of the plurality of luminaires in the illumination system. Sending the MLPS location information to the luminaire may include sending a current location of the MLPS to the luminaire over the at least one data communications channel. The MLPS location information to the luminaire may include sending a previous location of the MLPS to the luminaire over the at least one data communications channel. The MLPS location information may include sending GPS data provided by a GPS receiver associated with the MLPS to the luminaire. Sending the MLPS location information to the luminaire may include sending the MLPS location information to the luminaire over a short-range wireless communications channel or a wired communications channel. Sending the MLPS location information to the luminaire may include sending the MLPS location information to the luminaire over at least one of a Bluetooth®, WiFi®, near field communication (NFC), ANT®, or IEEE 802.15 channel. Sending the MLPS location information to the luminaire may include sending the MLPS location information to the luminaire via at least one of a smartphone, tablet computer, or notebook computer.

A mobile location provider system (MLPS) to provide luminaire information to a luminaire, the luminaire including at least one luminaire processor, at least one luminaire transceiver operatively coupled to the at least one luminaire processor and operatively coupled to at least one data communications channel, and at least one luminaire nontransitory processor-readable storage medium operatively coupled to the at least one luminaire processor may be summarized as including at least one MLPS processor; at least one MLPS transceiver operatively coupled to the at least one MLPS processor and to at least one data communications channel; and at least one MLPS nontransitory processor-readable storage medium operatively coupled to the at least one MLPS processor and storing MLPS location information indicative of a geographical location of the MLPS when the MLPS is positioned proximate the luminaire, the at least one MLPS nontransitory processor-readable storage medium further storing at least one of data or instructions which, when executed by the at least one MLPS processor, cause the at least one MLPS processor to: send, via the at least one MLPS transceiver, the MLPS location information to the luminaire over the at least one data communications channel for storage as luminaire location information on the at least one luminaire nontransitory processor-readable storage medium, the luminaire location information indicative of a geographical location of the luminaire. The at least one MLPS processor may send a current MLPS location information to the luminaire over the at least one data communications channel when the MLPS is positioned proximate the luminaire. The at least one MLPS processor may send a previous MLPS location information to the luminaire over the at least one data communications channel.

The MLPS may further include a global positioning system (GPS) receiver operatively coupled to the at least one MLPS processor; wherein the MLPS processor sends GPS data provided by the GPS receiver to the luminaire over the at least one data communications channel. The MLPS processor may send a current location of the MLPS to the luminaire over at least one of a short-range wireless communications channel or a wired communications channel. The short-range wireless communications channel may include at least one of a Bluetooth®, WiFi®, near field communication (NFC), ANT®, or IEEE 802.15 channel. The MLPS may include at least one of a smartphone, a tablet computer, or a notebook computer.

A method of operation to manage a plurality of remotely located luminaires in an illumination system may be summarized as including for each of the plurality of luminaires, positioning a mobile location provider system (MLPS) proximate the luminaire, the MLPS storing MLPS location information indicative of a geographical location of the MLPS when the MLPS is positioned proximate the luminaire; sending, by the MLPS, the MLPS location information to the luminaire over at least one data communications channel; storing, by at least one luminaire processor of the luminaire, the MLPS location information as luminaire location information for the luminaire in a nontransitory processor-readable storage medium, the luminaire location information indicative of a geographical location of the luminaire; and sending, by at least one luminaire transceiver of the luminaire, the luminaire location information to at least one asset management processor of an asset management system over the at least one data communications channel. The luminaire may be one luminaire in an illumination system including a plurality of luminaires, and positioning an MLPS proximate the luminaire may include positioning an MLPS a distance from the luminaire less than distances from respective other ones of the plurality of luminaires in the illumination system. Sending the luminaire location information may include sending the luminaire location information through at least one wireless communications channel. Sending the luminaire location information may include sending the luminaire location information through at least one power-line power distribution system.

The method may further include autonomously generating, by at the least one asset management processor, an electronic report based at least in part on the luminaire location information; and causing, by the at least one asset management processor, a user interface of a processor-based device to present the electronic report to a user. Autonomously generating an electronic report may include autonomously generating an electronic report that includes a map of the plurality of luminaires. Autonomously generating an electronic report may include autonomously generating a spreadsheet that includes the luminaire location information for each of the plurality of luminaires. Causing, by the at least one asset management processor, a user interface of a processor-based device to present the electronic report to a user may include sending the electronic report to a processor-based device associated with the user over the at least one data communications channel. Positioning the MLPS proximate the luminaire may include positioning the MLPS proximate the luminaire, the MLPS including a global positioning system (GPS) receiver, and sending the MLPS location information to the luminaire comprises sending GPS data provided by the GPS receiver to the luminaire. Sending the MLPS location information to the luminaire may include sending a current location of the MLPS to the luminaire over a short-range wireless communications channel. Sending the MLPS location information to the luminaire over a short-range wireless communications channel may include sending the current location of the MLPS to the luminaire over at least one of a Bluetooth®, WiFi®, near field communication (NFC), ANT®, or IEEE 802.15 channel. Sending the MLPS location information to the luminaire may include sending MLPS location information to the luminaire via at least one of a smartphone, tablet computer, or notebook computer.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an environment in which a luminaire management system may be implemented, according to at least one illustrated embodiment.

FIG. 2 is a functional block diagram of the luminaire management system of FIG. 1, according to at least one illustrated embodiment.

FIG. 3 is a functional block diagram of a mobile location provider system and a luminaire associated with the luminaire management system of FIG. 1, according to at least one illustrated embodiment.

FIG. 4 is a flow diagram showing a method of operation of a processor-based device to provide luminaires in an illumination system with location information and other luminaire information, according to at least one illustrated embodiment.

FIG. 5 is a flow diagram showing a method of operation of a processor-based device to manage luminaire information received from a plurality of luminaires in an illumination system, according to at least one illustrated embodiment.

FIG. 6 is an asset management table for a plurality of luminaires managed by the luminaire management system, according to at least one illustrated embodiment.

FIG. 7 is a luminaire management map depicting the locations of numerous luminaires and luminaire information for each of the luminaires, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the various embodiments have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Additionally, the terms “lighting,” “luminous output” and “illumination” are used herein interchangeably. For instance, the phrases “level of illumination” or “level of light output” have the same meanings. In addition, for instance, the phrases “illumination source” and “light source” have the same meanings.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

Systems, methods and articles of the present disclosure are directed to automatic collection of asset management data of outdoor illumination systems. In general, implementations discussed below provide autonomous collection of asset management data for outdoor luminaires, and organization of the collected data into electronic reports (e.g., spreadsheets, maps). The reports may be presented to a user via a processor-based device (e.g., smartphone, tablet, notebook computer, desktop computer, other “smart appliance”) associated with the user. Such asset management data or luminaire information may include, for example, unique identification information, location information, installation date, installation cost, installation details, type of luminaire, maintenance activities, specifications, purchase date, cost, expected lifetime, warranty information, service contracts, service history, spare parts, comments, or anything other information that may be useful to users (e.g., management, analysts, purchasers, installers, maintenance workers).

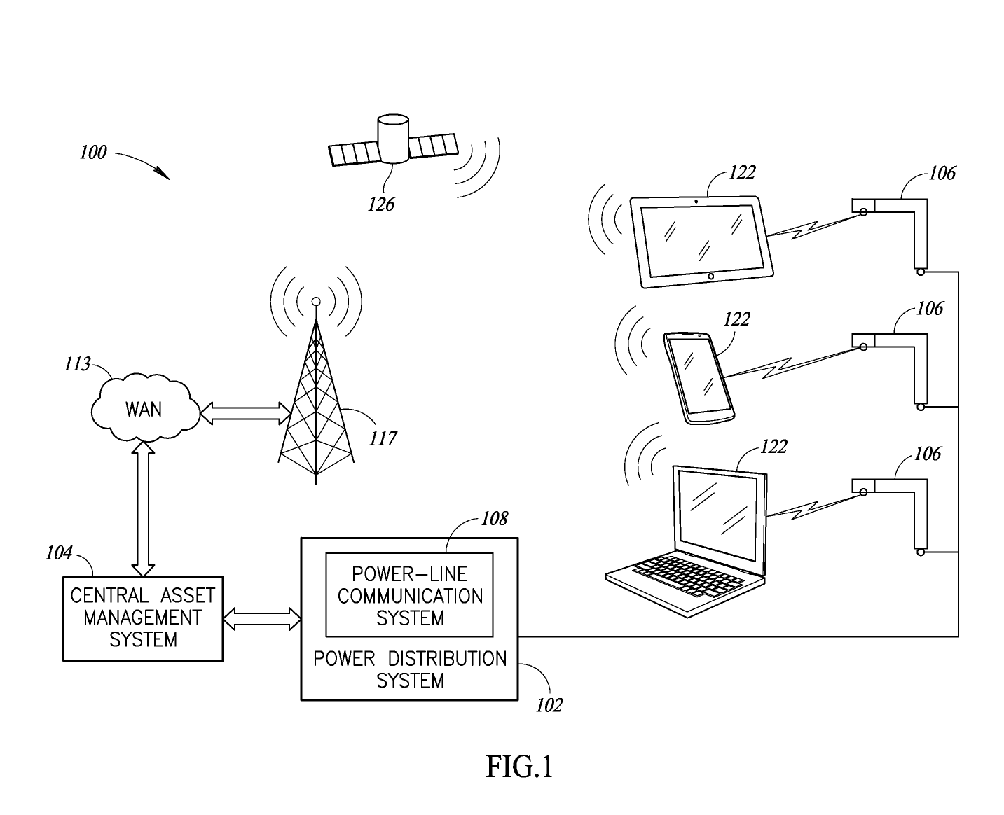

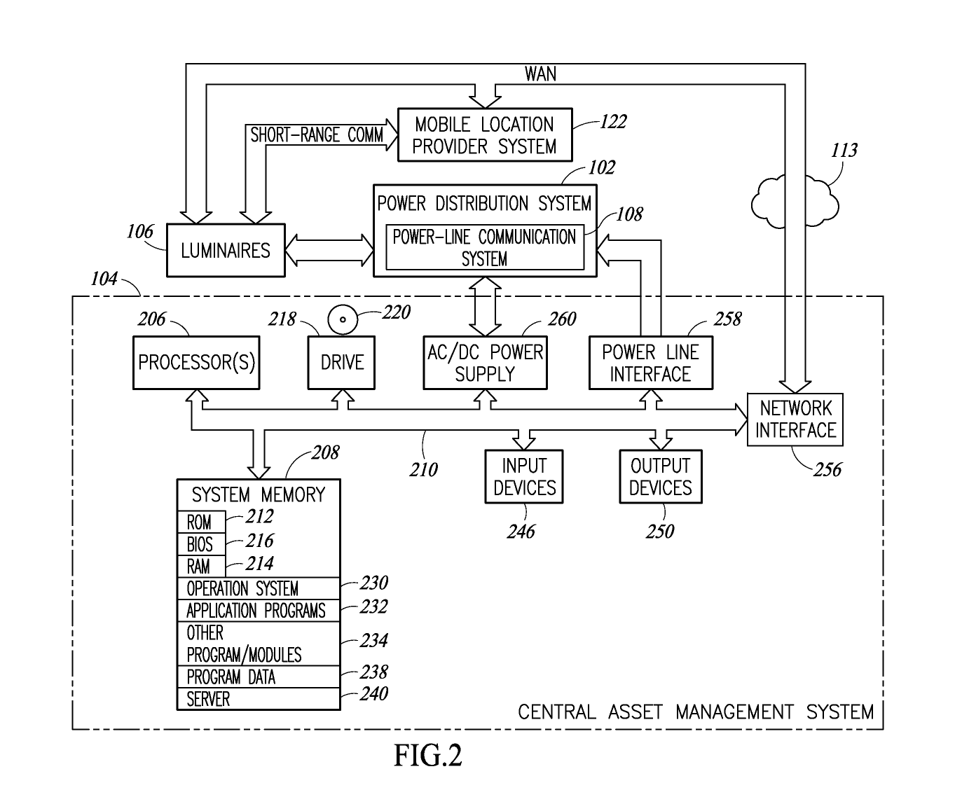

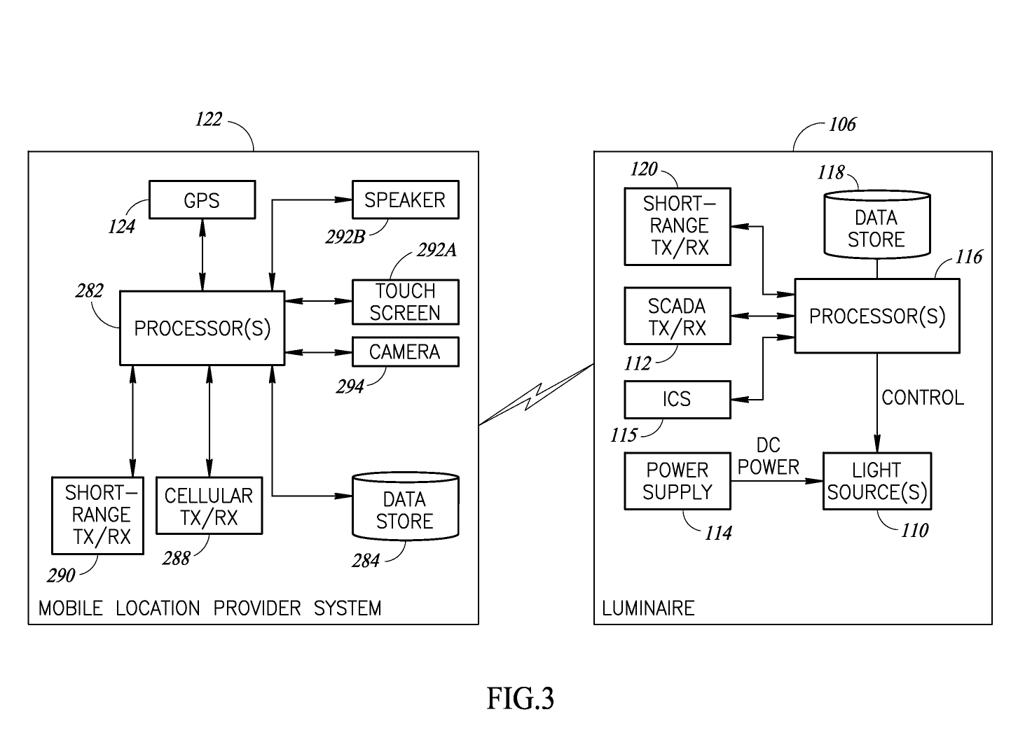

FIG. 1 illustrates a schematic block diagram of an illumination system 100 that includes a power distribution system 102, such as an alternating current (AC) network (e.g., power grid or mains) of a utility that includes one or more AC power sources, a central asset management system 104, a plurality of outdoor luminaires 106, and mobile location provider systems 120 positioned proximate each of the luminaires. The particular functional features of the central asset management system 104 are shown in FIG. 2, and the particular functional figures of the luminaires 106 and the mobile location provider systems 120 are shown in FIG. 3.

Three luminaires 106 are shown in FIG. 1, but it should be appreciated that the number of luminaires may vary depending on a particular application. For example, for applications wherein the luminaires 106 are part of an illumination system for a city, the number of luminaires may be in the hundreds or even thousands. As discussed further below, the central asset management system 104 and the plurality of luminaires 106 are communicatively coupled to a power-line communication system 108 of the power distribution system 102 to facilitate communications between the central asset management system and the plurality of luminaires via power lines of the power distribution system. In some implementations, the central asset management system 104 may additionally or alternatively communicate with the plurality of luminaires 106 via other types of networks or channels, such as one or more wired and/or wireless communications networks 113. In the illustrated embodiment, the luminaires 106 may wirelessly communicate with an access point 117 (e.g., cellular tower, WIFI® access point) operatively coupled to the one or more communication networks 113.

As shown in FIG. 3, each luminaire 106 includes one or more light sources 110, a power-line transceiver 112 (or other wired/wireless transceiver(s)), a power supply 114, a local illumination control system (ICS) 115, a luminaire processor 116, a nontransitory data store 118, and one or more wired/wireless short-range communications transceivers 120 (e.g., Bluetooth®, Wi-Fi®, USB®).

The transceivers 112 or 120 provide wired and/or wireless communications capabilities which allow the luminaires 106 to be communicatively coupled with the central asset management system 104 and one or more mobile location provider systems 122. For example, in some instances the central asset management system may be implemented as a supervisory control and data acquisition (SCADA) system. In these instances, the transceiver(s) 112 may include a SCADA transceiver that facilitates wireless communication and/or wired communication, such as communication over a power-line communication system.

The mobile location provider systems 122 may include accurate location identification systems, such as global positioning system (GPS) receivers 124 (FIG. 3) that communicate with GPS satellites 126 (FIG. 1). The mobile location provider systems 122 may also include one or more short-range wired or wireless communications capabilities (FIG. 3), such as one or more of Bluetooth®, WiFi®, near field communication (NFC), ANT®, IEEE 802.15 (e.g., ZigBee®), or USB®.

During installation, testing or setup of a luminaire 106, the mobile location provider system 122 positioned proximate the luminaire may transmit its location information (e.g., geographical coordinates) to the luminaire over a data communications channel (e.g., Bluetooth®, Wi-Fi®, USB®). Since the location information is near the luminaire 106 when the location information is determined, the luminaire may store the received location information as the luminaire's location in the data store 118, for example. In this regard, each of the installed luminaires “knows” its own geographical location.

In some implementations, each of the luminaires 106 is programmed with a unique identifier (e.g., identification number, such as a serial number). The unique identifier uniquely identifies the respective luminaire with respect to all other luminaires in an installation, or installed base, asset collection, or inventory of an entity. The unique identifier may be programmed or otherwise stored in the nontransitory data store 118 during manufacture, during installation, or at any other time. The unique identifier may be programmed using one of the mobile location provider systems 122, a factory programming fixture, DIP switches, or using any other suitable method.

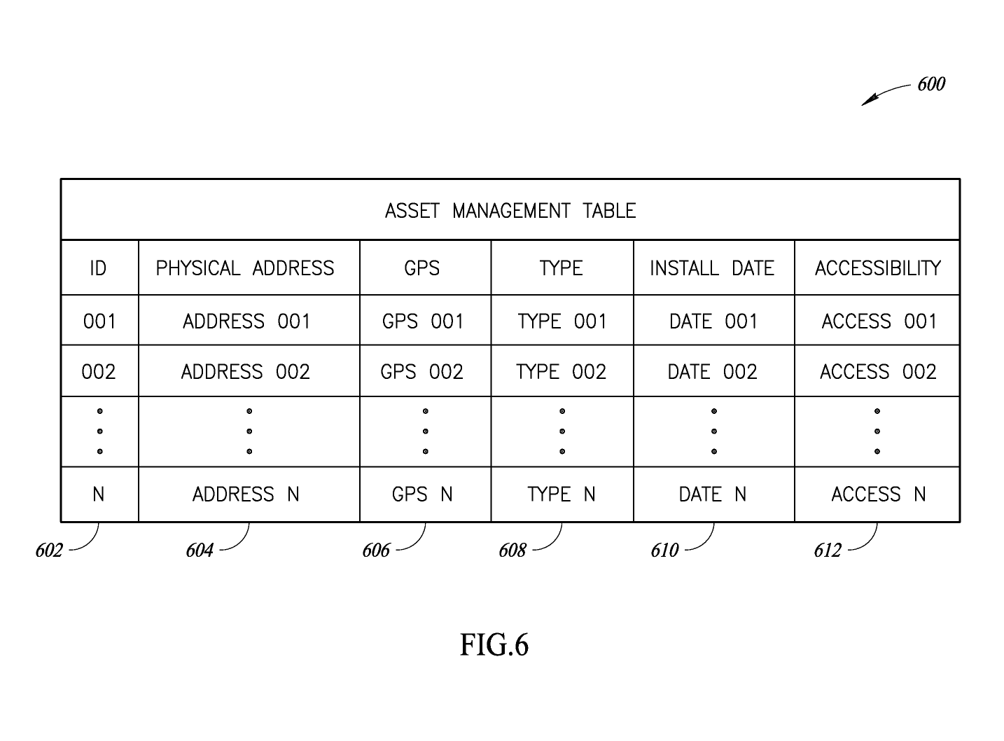

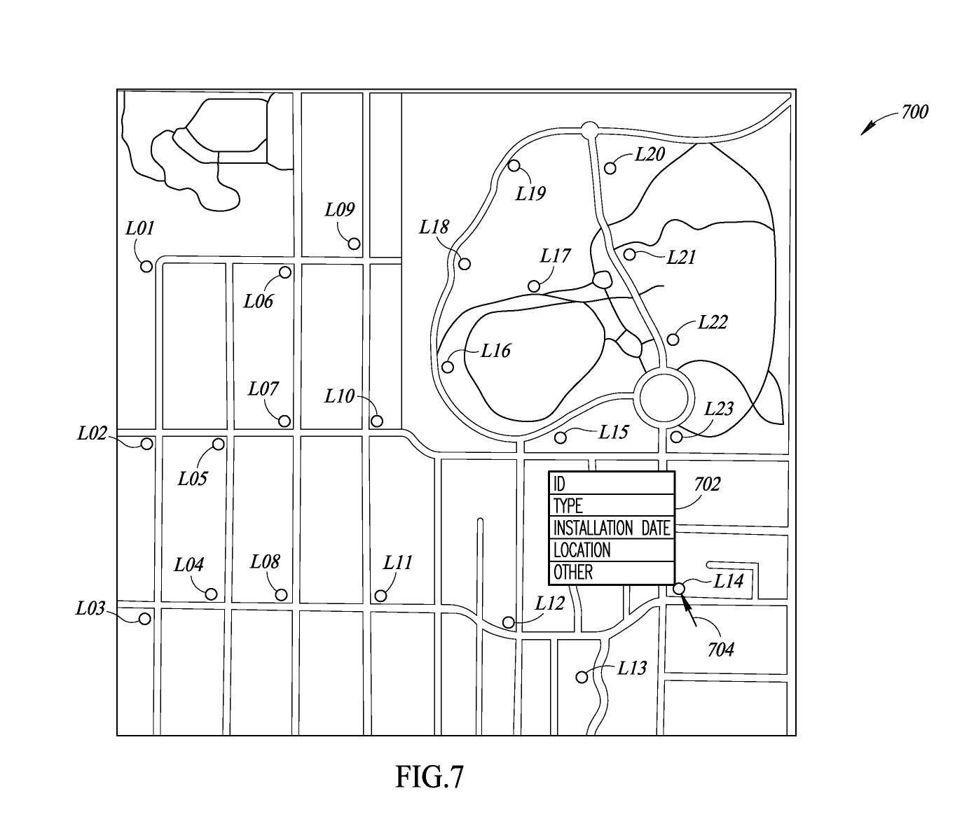

Once the luminaires 106 have received their respective identification information and location information, the luminaires may send such information to the central asset management system 104 for storage thereby. As discussed in further detail below, the central asset management system 104 may utilize the received luminaire information to build an asset management table (FIG. 6). The central asset management system 104 may also include mapping functions that generate an asset management map (FIG. 7) which may visually present luminaire information to one or more users. The central asset management system 104 may also analyze the collected data and generate one or more electronic reports that are valuable for users associated with the illumination system 100.

The local ICS 115 may include a photocontrol that has a photosensitive transducer (photosensor) associated therewith. The ICS 115 may be operative to control operation of the light sources 110 based on ambient light levels detected by the photosensor. The ICS 115 may be coupled to the processor 116 and operative to provide illumination data signals to the processor so that the processor may control the light sources 110 based on the received illumination data signals. The ICS 115 may also be configured as a switch that provides electrical power to the light sources 110 only when detected light levels are below a desired level. For example, the local ICS 115 of the luminaire 106 may include a photosensor that controls an electro-mechanical relay coupled between a source of electrical power and a control device (e.g., a magnetic or electronic transformer) within the luminaire. The electro-mechanical relay may be configured to be in an electrically continuous state unless a signal from the photosensor is present to supply power to the luminaire 106. If the photosensor is illuminated with a sufficient amount of light, the photosensor outputs the signal that causes the electro-mechanical relay to switch to an electrically discontinuous state such that no power is supplied to the luminaire 106.

In some implementations, the ICS 115 may include one or more clocks or timers, and/or one or more look-up tables or other data structures that indicate dawn events and dusk events for one or more geographical locations at various times during a year. The time of occurrence of various solar events may additionally or alternatively be calculated using geolocation, time, or date data either generated by or stored within a nontransitory processor-readable medium of the luminaire 106 or obtained from one or more external devices via one or more wired or wireless communication interfaces either in or communicably coupled to the luminaire. In some implementations, the ICS 115 is implemented partially or fully by the processor 116.

The power line transceiver 112 and the power supply 114 of the luminaire 106 may each be electrically coupled with the power distribution system 102 (FIG. 1). The power line transceiver 112 may transmit and receive power line control or data signals over the power distribution system 102, and the power supply 114 may receive a power signal from the power distribution system. The power line transceiver 112 may separate or decode the power line control or data signals from the power signals and may provide the decoded signals to the luminaire processor 116. In turn, the luminaire processor 116 may generate one or more light source control commands that are supplied to the light sources 110 to control the operation thereof. The power line transceiver 112 may also encode power line control or data signals and transmit the signals to the central asset management system 104 via the power distribution system 102.

The power supply 114 may receive an AC power signal from the power distribution system 102, generate a DC power output, and supply the generated DC power output to the light sources 110 to power the light sources as controlled by light source control commands from the luminaire processor 116.

The light sources 110 may include one or more of a variety of conventional light sources, for example, incandescent lamps or fluorescent lamps such as high-intensity discharge (HID) lamps (e.g., mercury vapor lamps, high-pressure sodium lamps, metal halide lamps). The light sources 110 may also include one or more solid-state light sources (e.g., light emitting diodes (LEDs), organic LEDs (OLEDs), polymer LEDs (PLEDs)).

The central asset management system 104 may receive luminaire information from each of the luminaires 106 in the illumination system 100. For example, in some implementations the central asset management system 104 may interrogate the luminaires 106 (e.g., via the power distribution system 102) and receive signals from each of the luminaires that provide luminaire information. In some implementations, the luminaires 106 may automatically send luminaire information to the central asset management system without interrogation.

The central asset management system 104 may store the luminaire information in one or more nontransitory computer- or processor-readable media. The luminaire information may include, for example, identification information, location information, installation date, installation cost, installation details, type of luminaire, maintenance activities, specifications, purchase date, cost, expected lifetime, warranty information, service contracts, service history, spare parts, comments, or anything other information that may be useful to users (e.g., management, analysts, purchasers, installers, maintenance workers).

In some implementations, data communicated between the central asset management system 104 and the luminaires 106 may be converted into power line control signals that may be superimposed onto wiring of the power distribution system 102 so that the signals are transmitted or distributed via the power distribution system. In some implementations, the power line signals may be in the form of amplitude modulation signals, frequency modulation signals, frequency shift keyed signals (FSK), differential frequency shift keyed signals (DFSK), differential phase shift keyed signals (DPSK), or other types of signals. The command code format of the power line signals may be that of a commercially available controller format or may be that of a custom controller format. An example power line communication system is the TWACS® system available from Aclara Corporation, Hazelwood, Mo.

The central asset management system 104 may utilize a power line transceiver or interface 258 (see FIG. 2) that includes special coupling capacitors to connect transmitters to power-frequency AC conductors of the power distribution system 102. Signals may be impressed on one conductor, on two conductors or on all three conductors of a high-voltage AC transmission line. Filtering devices may be applied at substations of the power distribution system 102 to prevent the carrier frequency current from being bypassed through substation infrastructure. Power line carrier systems may be favored by utilities because they allow utilities to reliably move data over an infrastructure that they control.

In some instances, the power line signals may be in the form of a broadcast signal or command delivered to each of the luminaires 106 in the illumination system 100. In some instances, the power line signals may be specifically addressed to an individual luminaire 106, or to one or more groups or subsets of luminaires.

FIGS. 2 and 3 and the following discussion provide a brief, general description of the components forming the illustrative illumination system 100 including the central asset management system 104, the power distribution system 102, the mobile location provider systems 122, and the luminaires 106 in which the various illustrated embodiments can be implemented. Although not required, some portion of the embodiments will be described in the general context of computer-executable instructions or logic and/or data, such as program application modules, objects, or macros being executed by a computer. Those skilled in the relevant art will appreciate that the illustrated embodiments as well as other embodiments can be practiced with other computer system or processor-based device configurations, including handheld devices, for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The central asset management system 104 may take the form of a PC, server, or other computing system executing logic or other machine executable instructions. The central asset management system 104 includes one or more processors 206, a system memory 208 and a system bus 210 that couples various system components including the system memory 208 to the processor 206. The central asset management system 104 will at times be referred to in the singular herein, but this is not intended to limit the embodiments to a single system, since in certain embodiments, there will be more than one central asset management system 104 or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The central asset management system 104 may be implemented as a SCADA system or as one or more components thereof. Generally, a SCADA system is a system operating with coded signals over communication channels to provide control of remote equipment. The supervisory system may be combined with a data acquisition system by adding the use of coded signals over communication channels to acquire information about the status of the remote equipment for display or for recording functions.

The processor 206 may be any logic processing unit, such as one or more central processing units (CPUs), microprocessors, digital signal processors (DSPs), graphics processors (GPUs), application-specific integrated circuits (ASICs), field programmable gate arrays (FPGAs), etc. Unless described otherwise, the construction and operation of the various blocks shown in FIGS. 2 and 3 are of conventional design. As a result, such blocks need not be described in further detail herein, as they will be understood by those skilled in the relevant art.

The system bus 210 can employ any known bus structures or architectures. The system memory 208 includes read-only memory (“ROM”) 212 and random access memory (“RAM”) 214. A basic input/output system (“BIOS”) 216, which may be incorporated into at least a portion of the ROM 212, contains basic routines that help transfer information between elements within the central asset management system 104, such as during start-up. Some embodiments may employ separate buses for data, instructions and power.

The central asset management system 104 also may include one or more drives 218 for reading from and writing to one or more nontransitory computer- or processor-readable media 220 (e.g., hard disk, magnetic disk, optical disk). The drive 218 may communicate with the processor 206 via the system bus 210. The drive 218 may include interfaces or controllers (not shown) coupled between such drives and the system bus 210, as is known by those skilled in the art. The drives 218 and their associated nontransitory computer- or processor-readable media 220 provide nonvolatile storage of computer-readable instructions, data structures, program modules and other data for the central asset management system 104. Those skilled in the relevant art will appreciate that other types of computer-readable media may be employed to store data accessible by a computer.

Program modules can be stored in the system memory 208, such as an operating system 230, one or more application programs 232, other programs or modules 234, and program data 238.

The application program(s) 232 may include logic capable of providing the luminaire management functionality described herein. For example, applications programs 232 may include programs to analyze and organize luminaire information automatically received from the luminaires 106. The application programs 232 may also include programs to present raw or analyzed illumination information in a format suitable for presentation to a user.

The system memory 208 may include communications programs 240 that permit the central asset management system 104 to access and exchange data with other networked systems or components, such as the luminaires 106, the mobile location provider systems 122, and/or other computing devices.

While shown in FIG. 2 as being stored in the system memory 208, the operating system 230, application programs 232, other programs/modules 234, program data 238 and communications 240 can be stored on the nontransitory computer- or processor-readable media 220 or other nontransitory computer- or processor-readable media.

Personnel can enter commands (e.g., system maintenance, upgrades) and information (e.g., parameters) into the central asset management system 104 using one or more communicably coupled input devices 246 such as a touch screen or keyboard, a pointing device such as a mouse, and/or a push button. Other input devices can include a microphone, joystick, game pad, tablet, scanner, biometric scanning device, etc. These and other input devices may be connected to the processing unit 206 through an interface such as a universal serial bus (“USB”) interface that couples to the system bus 210, although other interfaces such as a parallel port, a game port or a wireless interface or a serial port may be used. One or more output devices 250, such as a monitor or other display device, may be coupled to the system bus 210 via a video interface, such as a video adapter. In at least some instances, the input devices 246 and the output devices 250 may be located proximate the central asset management system 104, for example when the system is installed at the system user's premises. In other instances, the input devices 246 and the output devices 250 may be located remote from the central asset management system 104, for example when the system is installed on the premises of a service provider.

In some implementations, the central asset management system 104 uses one or more of the logical connections to optionally communicate with one or more luminaires 106, remote computers, servers and/or other devices via one or more communications channels, for example, the one or more networks 113. These logical connections may facilitate any known method of permitting computers to communicate, such as through one or more LANs and/or WANs. Such networking environments are known in wired and wireless enterprise-wide computer networks, intranets, extranets, and the Internet.

In some implementations, a network port or interface 256, communicatively linked to the system bus 210, may be used for establishing and maintaining communications over the communications network 113.

The central asset management system 104 may include a power line transceiver or interface 258 and an AC/DC power supply 260 that are each electrically coupled to the power distribution system 102. The AC/DC power supply 260 converts AC power from the power distribution system 102 into DC power, which may be provided to power the various components of the central asset management system 104. As discussed above, the power line interface 258 may be operative to superimpose control signals onto one or more conductors of the power distribution system 102 that carries power to the luminaires 106. The power line interface 258 may also be operative to decode and receive communication signals sent over the power distribution system 102 (e.g., from the power line interface 112 of a luminaire 106 (FIG. 1)).

In some implementations, the central asset management system 104 may utilize the one or more wired and/or wireless communications networks 113 to communicate with the luminaires 106 instead of or in addition to communicating through the power distribution system 102.

In the illumination system 100, program modules, application programs, or data, or portions thereof, can be stored in one or more computing systems. Those skilled in the relevant art will recognize that the network connections shown in FIG. 2 are only some examples of ways of establishing communications between computers, and other connections may be used, including wireless. In some embodiments, program modules, application programs, or data, or portions thereof, can even be stored in other computer systems or other devices (not shown).

For convenience, the processor 206, system memory 208, network port 256 and devices 246, 250 are illustrated as communicatively coupled to each other via the system bus 210, thereby providing connectivity between the above-described components. In alternative embodiments, the above-described components may be communicatively coupled in a different manner than illustrated in FIG. 2. For example, one or more of the above-described components may be directly coupled to other components, or may be coupled to each other, via intermediary components (not shown). In some embodiments, system bus 210 is omitted and the components are coupled directly to each other using suitable connections.

It should be appreciated that the luminaires 106 may include components similar to those components present in the central asset management system 104, including the processor 206, power supply 260, power line interface 258, buses, nontransitory computer- or processor-readable media, wired or wireless communications interfaces, and one or more input and/or output devices.

The mobile location provider system 122 can include any device, system or combination of systems and devices having at least wired or wireless communications capabilities. In most instances, the mobile location provider system 122 includes additional devices, systems, or combinations of systems and devices capable of providing graphical data display capabilities. Examples of such systems 122 can include without limitation, cellular telephones, smart phones, tablet computers, desktop computers, laptop computers, ultraportable or netbook computers, personal digital assistants, handheld devices, other smart appliances, and the like.

In other implementations, the luminaire includes a satellite positioning receiver such as GPS receiver, Glonass, etc., and stores its position data in nontransitory computer- or processor-readable media or memory. The position data may only need to be acquired relatively infrequently, thus enabling location data to be acquired in poor reception areas or with relatively low cost receiver hardware.

The mobile location provider system 122 may include one or more processors 282 and nontransitory computer- or processor-readable media or memory, for instance one or more data stores 284 that may include nonvolatile memories such as read only memory (ROM) or FLASH memory and/or one or more volatile memories such as random access memory (RAM).

The mobile location provider system 122 may include one or more transceivers or radios and associated antennas. For example, the mobile location provider system 122 may include one or more cellular transceivers or radios 288 and one or more short-range transceivers or radios 290, such as WIFI® transceivers or radios, BLUETOOTH® transceivers or radios, along with associated antennas. The mobile location provider system 122 may further include one or more wired interfaces (not shown) that utilize parallel cables, serial cables, or wireless channels capable of high speed communications, for instance, via one or more of FireWire®, Universal Serial Bus® (USB), Thunderbolt®, or Gigabit Ethernet®, for example.

The mobile location provider system 122 may include a user input/output subsystem, for example including a touchscreen or touch sensitive display device 292A and one or more speakers 292B. The touchscreen or touch sensitive display device 292A may include any type of touchscreen including, but not limited to, a resistive touchscreen or a capacitive touchscreen. The touchscreen or touch sensitive display device 292A may present a graphical user interface, for example in the form of a number of distinct screens or windows, which include prompts and/or fields for selection. The touchscreen or touch sensitive display device 292A may present or display individual icons and controls, for example virtual buttons or slider controls and virtual keyboard or key pads which are used to communicate instructions, commands, and/or data. While not illustrated, the user interface may additionally or alternatively include one or more additional input or output devices, for example an alphanumeric keypad, a QWERTY keyboard, a joystick, scroll wheel, touchpad or similar physical or virtual input device.

The mobile location provider system 122 may include one or more image capture devices 294, for example, cameras with suitable lenses, and optionally one or more flash or lights for illuminating a field of view to capture images. The image capture device(s) 294 may capture still digital images or moving or video digital images. Image information may be stored as files via the data store 284, for example.

Some or all of the components within the mobile location provider system 122 may be communicably coupled using at least one bus (not shown) or similar structure adapted to transferring, transporting, or conveying data between the devices, systems, or components used within the mobile location provider system 122. The bus can include one or more serial communications links or a parallel communications link such as an 8-bit, 16-bit, 32-bit, or 64-bit data bus. In some embodiments, a redundant bus (not shown) may be present to provide failover capability in the event of a failure or disruption of a primary bus.

The processor(s) 282 may include any type of processor (e.g., ARM Cortext-A8, ARM Cortext-A9, Snapdragon 600, Snapdragon 800, NVidia Tegra 4, NVidia Tegra 4i, Intel Atom Z2580, Samsung Exynos 5 Octa, Apple A7, Motorola X8) adapted to execute one or more machine executable instruction sets, for example a conventional microprocessor, a reduced instruction set computer (RISC) based processor, an application specific integrated circuit (ASIC), digital signal processor (DSP), or similar. Within the processor(s) 282, a non-volatile memory may store all or a portion of a basic input/output system (BIOS), boot sequence, firmware, startup routine, and communications device operating system (e.g., iOS®, Android®, Windows® Phone, Windows® 8, and similar) executed by the processor 282 upon initial application of power. The processor(s) 282 may also execute one or more sets of logic or one or more machine executable instruction sets loaded from volatile memory subsequent to the initial application of power to the processor 282. The processor 282 may also include a system clock, a calendar, or similar time measurement devices. One or more geolocation devices, for example a Global Positioning System (GPS) receiver 124 may be communicably coupled to the processor 282 to provide additional functionality such as geolocation data to the processor 282.

The transceivers or radios 288, 290 can include any device capable of transmitting and receiving communications via electromagnetic energy.

Non-limiting examples of cellular communications transceivers or radios 288 include a CDMA transceiver, a GSM transceiver, a 3G transceiver, a 4G transceiver, an LTE transceiver, and any similar current or future developed computing device transceiver having at least one of a voice telephony capability or a data exchange capability. In at least some instances, the cellular transceivers or radios 288 can include more than one interface. For example, in some instances, the cellular transceivers or radios 288 can include at least one dedicated, full- or half-duplex, voice call interface and at least one dedicated data interface. In other instances, the cellular transceivers or radios 288 can include at least one integrated interface capable of contemporaneously accommodating both full- or half-duplex voice calls and data transfer.

Non-limiting examples of WIFI® short-range transceivers or radios 290 include various chipsets available from Broadcom, including BCM43142, BCM4313, BCM94312MC, BCM4312, and chipsets available from Atmel, Marvell, or Redpine. Non-limiting examples of Bluetooth® short-range transceivers or radios 288 include various chipsets available from Nordic Semiconductor, Texas Instruments, Cambridge Silicon Radio, Broadcom, and EM Microelectronic.

As noted, the data store 284 can include non-volatile storage memory and in some embodiments may include volatile memory as well. At least a portion of the data store 284 may be used to store one or more processor executable instruction sets for execution by the processor 282. In some embodiments, all or a portion of the memory may be disposed within the processor 282, for example in the form of a cache. In some embodiments, the memory may be supplemented with one or more slots configured to accept the insertion of one or more removable memory devices such as a secure digital (SD) card, a compact flash (CF) card, a universal serial bus (USB) memory “stick,” or the like.

In at least some implementations, one or more sets of logic or machine executable instructions providing applications or “apps” executable by the processor 282 may be stored in whole or in part in at least a portion of the memory 284. In at least some instances, the applications may be downloaded or otherwise acquired by the end user, for example using an online marketplace such as the Apple App Store, Amazon Marketplace, or Google Play marketplaces. In some implementations, such applications may start up in response to selection of a corresponding user selectable icon by the user or consumer. The application can facilitate establishing a data link between the mobile location provider system 122 and the central asset management system 104 or the luminaires 106 via the transceivers or radios 288, 290 and communication networks 113.

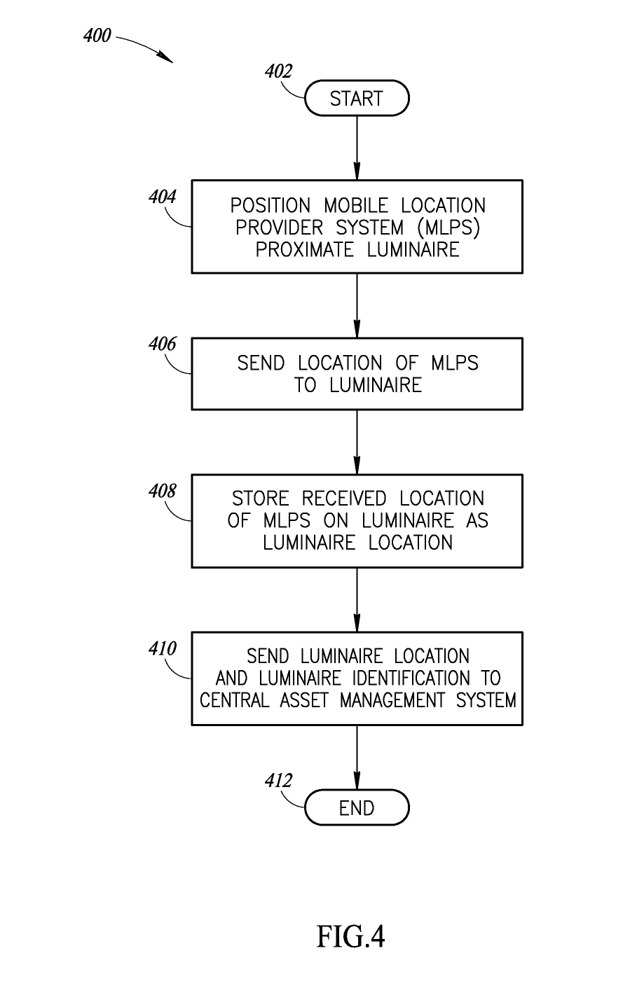

FIG. 4 is a flow diagram showing a method 400 of operation of a processor-based device to provide installed luminaires in an illumination system with location information and optionally other luminaire information. The method 400 starts at 402. For example, the method 400 may start in response to commissioning an illumination system, such as the illumination system 100 shown in FIG. 1.

At 404, a mobile location provider system is positioned proximate to an installed luminaire. Examples of mobile location provider systems can include without limitation, cellular telephones, smart phones, tablet computers, desktop computers, laptop computers, ultraportable or netbook computers, personal digital assistants, handheld devices, other smart appliances, and the like. For instance, an installer or technician may stand near an installed luminaire with a mobile location provider system during installation, testing or setup of the luminaire. As noted above, the mobile location provider system includes a location identification system, such as a GPS receiver, that provides the mobile location provider system with its current geographical location. In some implementations, the mobile location provider system may include an interface that allows a user to manually input geographical location information (e.g., physical address, GPS coordinates) into the mobile location provider system. In some implementations, the mobile location provider system may interface or communicate with a processor-based device (e.g., external GPS, remote server) that operates to provide the mobile location provider system with its current geographical location information.

Generally, during location measurement the mobile location provider system should be positioned close enough to the luminaire so that the location of the mobile location provider system is sufficiently similar to the location of the luminaire for a particular application. For example, the user may stand with the mobile location provider system within about 200 feet, 50 feet, 25 feet, 10 feet, or 5 feet from the luminaire. The maximum distance allowable between the mobile location provider system and the luminaire during the location measurement is dependent on the accuracy desired for the location of the luminaire.

At 406, the mobile location provider system sends its current location to the nearby luminaire over a suitable wired or wireless short-range communications channel. For example, the mobile location provider system may transmit its location information to the nearby luminaire using Bluetooth®, WiFi®, near field communication (NFC), ANT®, IEEE 802.15, or USB®. The maximum distance allowable between the mobile location provider system and the luminaire during communication therebetween is dependent on the range of the particular communication protocol utilized.

In some implementations, the mobile location provider system may send a unique identifier, such as a serial number, to the luminaire for storage in a nontransitory processor-readable storage medium of the luminaire (FIG. 3). The unique identifier may be programmed or otherwise stored in a data store of the luminaire during manufacture, during installation, or at any other time. The unique identifier may be programmed using the mobile location provider system, a factory programming fixture, DIP switches, or using any other suitable method. In some implementations, the mobile location provider system may send additional luminaire information to the luminaire, such as installation date, technician name or ID, etc.

At 408, the luminaire may store the received location information from the nearby mobile location provider system on a nontransitory processor-readable storage medium as the location of the luminaire. Thus, by using the location identification system of the mobile location provider system, the luminaire may store its own accurate location information.

At 410, the luminaire may send the luminaire information, such as the location of the luminaire and a unique identifier, to the central asset management system over a suitable wired and/or wireless data communications channel, such as the communications network 113 or the power-line communication system 108 of FIG. 1.

The method 400 ends at 416 until started or invoked again. For example, the method 400 may be performed for each luminaire in an illumination system to provide each luminaire with its location information and/or other information about the luminaire. The method 400 may also be repeated for a luminaire after certain events, such as a maintenance event or a relocation event.

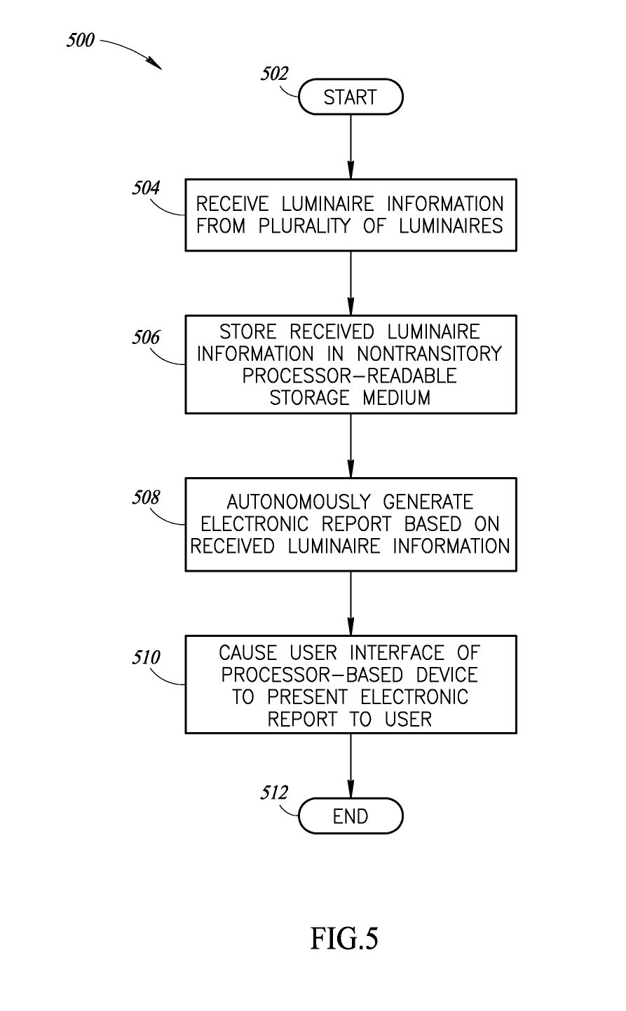

FIG. 5 is a flow diagram showing a method 500 of operation of a processor-based device to manage luminaire information received from a plurality of luminaires in an illumination system. The method 500 starts at 502. For example, the method 500 may start in response to commissioning an illumination system, such as the illumination system 100 shown in FIG. 1.

At 504, the central asset management system may receive luminaire information from a plurality of luminaires. For example, the central asset management system may interrogate a plurality of luminaires via a power line communication system or other wired or wireless communications system to cause the luminaires to send their respective illumination information to the central asset management system. Additionally or alternatively, individual luminaires may automatically send illumination information to the central asset management system from time to time without receiving an interrogation.

At 506, the central asset management system stores the received luminaire information in a nontransitory processor-readable storage medium (e.g., storage medium 220 of FIG. 2).

At 508, the central asset management system autonomously generates an electronic report based at least in part on the luminaire information received from the plurality of luminaires. As shown in FIG. 6, the central asset management system may generate an asset management table or spreadsheet based on the luminaire information. As another example, as shown in FIG. 7 the central asset management system may generate a map that shows the various luminaires in an illumination system as well as particular information regarding each of the luminaires. The central asset management system may perform various analysis on the asset data to provide users with reports that present information in valuable or desired formats.

At 510, the central asset management system causes a user interface of a processor-based device to present the generated electronic report to a user associated with the processor-based device. For example, the central asset management system may cause a spreadsheet or map to be displayed on a desktop computer, laptop computer, tablet computer, or smartphone of a user (e.g., management, analysts, purchasers, installers, maintenance workers) communicatively coupled to the central asset management system.

The method 500 ends at 512 until started or invoked again. For example, the method 500 may be operated substantially continuously for an extended duration (e.g., years) as luminaires periodically send luminaire information to the central asset management system. The method 500 may also be operated when a user requests generation of a report, such as a spreadsheet or a map. It should be appreciated that one advantage provided by the implementations of the present disclosure is that the central asset management system collects luminaire information automatically an organizes it into valuable reports, without requiring laborious, costly and error prone manual entry of the luminaire information. Further, the central asset management system may be in the form of one or more local asset management systems, regional asset management systems, etc.

As discussed above, the central asset management system may store received luminaire information in a database or other nontransitory processor-readable storage medium. FIG. 6 illustrates an exemplary asset management table 600 that may be autonomously generated by the central asset management system based on the received luminaire information. The asset management table 600 may be stored in a nontransitory processor-readable data storage communicatively coupled to the central asset management system. The asset management table 600 may be displayed to a user on an output device (e.g., a monitor, touchscreen) of a processor-based device operative to receive data directly or indirectly from the central asset management system via a suitable communication channel.

In the illustrated implementation, the asset management table 600 includes various information about each luminaire in an illumination system. Specifically, for each luminaire, the asset management table 600 includes: a luminaire identifier 602, a physical address 604 of the luminaire, GPS coordinates 606 of the luminaire, luminaire type 608, installation date 610, and accessibility information 612 for the luminaire. These categories are provided as non-limiting examples of luminaire information that may be provided. The physical address 604 may be a postal address or any other address providing location information to the user. The luminaire type 608 may include a model description or part number so that, for example, a user of the system may know which parts to order for repair or replacement. The installation date 610 may indicate the date the luminaire was installed. Accessibility information 612 may include information helpful for planning repair or replacement of the luminaire if needed. For example, accessibility information 612 may include the height of the luminaire so technicians will know what equipment is needed to reach the luminaire to repair or replace the failed luminaire.

In some implementations, the central asset management system generates a map of luminaires of an illumination system so that users may visualize the locations of the luminaires. FIG. 7 illustrates a map 700 that may be generated by the central asset management system. The map 700 depicts a plurality of icons L01-L23 for plurality of respective luminaires positioned at various locations throughout a geographical area (e.g., a city). The map 700 may be displayed to a user on an output device (e.g., a monitor, touchscreen) of a computing device operative to receive data from the central asset management system.

The map 700 may display a window 702 that includes luminaire information for one or more luminaires of the illumination system. In the illustrated example, the window 702 is a pop-up window that displays information for the luminaire depicted by the icon L14 when a cursor 704 hovers over the icon. In other embodiments, the window 702 may be displayed when a user selects one of the icons L01-L23 using any suitable input selection method (e.g., touch, keyboard, manual entry).

The information provided in the table 600, map 700 or window 702 may be varied or configured as desired for a particular user or a particular application. For instance, a user may be interested in viewing only a particular subset of the luminaires in an illumination system. As non-limiting examples, a user may be interest in viewing only those luminaires that have an expected life of less than one year, only those luminaires that were installed within the past six months, or only those luminaires within a two mile radius of a service depot. As another non-limiting example, the user may be interested in viewing only a subset of the luminaire information available for each luminaire, such as only the serial numbers of each of the luminaires.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and/or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, and U.S. patent applications referred to in this specification and/or listed in the Application Data Sheet, including but not limited to U.S. Provisional Patent Application No. 61/052,924, filed May 13, 2008; U.S. Patent Publication No. US 2009/0284155, published Nov. 19, 2009; U.S. Provisional Patent Application No. 61/051,619, filed May 8, 2008; U.S. Pat. No. 8,118,456, issued Feb. 12, 2012; U.S. Provisional Patent Application No. 61/088,651, filed Aug. 13, 2008; U.S. Patent Publication No. US 2010/0090577, published Apr. 15, 2010; U.S. Provisional Patent Application No. 61/115,438, filed Nov. 17, 2008; U.S. Provisional Patent Application No. 61/154,619, filed Feb. 23, 2009; U.S. Patent Publication No. US2010/0123403, published May 20, 2010; U.S. Provisional Patent Application No. 61/174,913, filed May 1, 2009; U.S. Patent Publication No. US2010/0277082, published Nov. 4, 2010; U.S. Provisional Patent Application No. 61/180,017, filed May 20, 2009; U.S. Patent Publication No. US2010/0295946, published Nov. 25, 2010; U.S. Provisional Patent Application No. 61/229,435, filed Jul. 29, 2009; U.S. Patent Publication No. US2011/0026264, published Feb. 3, 2011; U.S. Provisional Patent Application No. 61/295,519, filed Jan. 15, 2010; U.S. Provisional Patent Application No. 61/406,490, filed Oct. 25, 2010; U.S. Patent Publication No. US2011/0175518, published Jul. 21, 2011; U.S. Provisional Patent Application Ser. No. 61/333,983, filed May 12, 2010; U.S. Patent Publication No. US2010/0295454, published Nov. 25, 2010; U.S. Provisional Patent Application Ser. No. 61/346,263, filed May 19, 2010; U.S. Patent Publication No. US2010/0295455, published Nov. 25, 2010; U.S. Provisional Patent Application Ser. No. 61/357,421, filed Jun. 22, 2010; U.S. Patent Publication No. US2011/0310605, published Dec. 22, 2011; U.S. Patent Publication No. 2012/0262069, published Oct. 18, 2012; U.S. Non-Provisional patent application Ser. No. 13/212,074, filed Aug. 17, 2011; U.S. Provisional Patent Application Ser. No. 61/527,029, filed Aug. 24, 2011; U.S. Non-Provisional patent application Ser. No. 13/592,590, filed Aug. 23, 2012; U.S. Provisional Patent Application Ser. No. 61/534,722, filed Sep. 14, 2011; U.S. Non-Provisional patent application Ser. No. 13/619,085, filed Sep. 14, 2012; U.S. Provisional Patent Application Ser. No. 61/567,308, filed Dec. 6, 2011; U.S. Provisional Patent Application Ser. No. 61/561,616, filed Nov. 18, 2011; U.S. Provisional Patent Application Ser. No. 61/641,781, filed May 2, 2012; U.S. Non-Provisional patent application Ser. No. 13/411,321, filed Mar. 2, 2012; U.S. Provisional Patent Application Ser. No. 61/640,963, filed May 1, 2012; U.S. Provisional Patent Application No. 61/764,395, filed Feb. 13, 2013; U.S. Non-Provisional patent application Ser. No. 13/558,191, filed Jul. 25, 2012; U.S. Provisional Patent Application Ser. No. 61/692,619, filed Aug. 23, 2012; U.S. Provisional Patent Application Ser. No. 61/694,159, filed Aug. 28, 2012; U.S. Non-Provisional patent application Ser. No. 13/604,327, filed Sep. 5, 2012; U.S. Provisional Patent Application Ser. No. 61/723,675, filed Nov. 7, 2012; U.S. Non-Provisional patent application Ser. No. 13/679,687, filed Nov. 16, 2012; U.S. Provisional Patent Application Ser. No. 61/728,150, filed Nov. 19, 2012; U.S. Provisional Patent Application Ser. No. 61/764,395, filed Feb. 13, 2013; Provisional patent application Ser. No. 13/786,114, filed Mar. 5, 2013; U.S. Non-Provisional patent application Ser. No. 13/786,332, filed Mar. 5, 2013; U.S. Non-Provisional patent application Ser. No. 13/875,000, filed May 1, 2013; U.S. Provisional Patent Application No. 61/849,841, filed Jul. 24, 2013; U.S. Provisional patent application Ser. No. 13/973,696, filed Aug. 22, 2013; U.S. Provisional Patent Application No. 61/878,425, filed Sep. 16, 2013; U.S. Non-Provisional patent application Ser. No. 14/074,166, filed Nov. 7, 2013; U.S. Provisional Patent Application No. 61/905,699, filed Nov. 18, 2013; U.S. Provisional Patent Application No. 61/933,733, filed Jan. 30, 2014; U.S. Provisional Patent Application No. 62/057,419, filed Sep. 30, 2014, U.S. Provisional Patent Application No. 62/068,517, filed Oct. 24, 2014 and U.S. Non-Provisional patent application Ser. No. 14/546,354 filed on Nov. 18, 2014; U.S. Provisional Patent Application No. 62/183,505, filed Jun. 23, 2015; and U.S. Provisional Patent Application No. 62/082,463, filed Nov. 20, 2014 are incorporated herein by reference in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation for a luminaire to permit management thereof by an asset management system located remote from the luminaire, the method comprising:
storing luminaire identification information in at least one nontransitory processor-readable storage medium of the luminaire, the luminaire identification information uniquely identifies the luminaire;
receiving, by at least one luminaire transceiver of the luminaire, mobile location provider system (MLPS) location information from an MLPS over at least one data communications channel, the MLPS location information indicative of a geographical location of the MLPS when the MLPS is positioned proximate the luminaire;
storing the received MLPS location information in at least one nontransitory processor-readable storage medium of the luminaire as luminaire location information for the luminaire, the luminaire location information indicative of a geographical location of the luminaire; and
sending, by at least one luminaire transceiver of the luminaire operatively coupled to the at least one data communications channel, the luminaire location information and the luminaire identification information to the asset management system over the at least one data communications channel.

2. The method of claim 1 wherein receiving MLPS location information from an MLPS over at least one data communications channel comprises receiving MLPS location information from an MLPS over at least one data communications channel, the MLPS location information indicative of a geographical location of the MLPS when the MLPS is positioned within 50 feet of the luminaire.

3. The method of claim 1 wherein receiving MLPS location information from an MLPS over the at least one data communications channel comprises receiving MLPS location information from an MLPS by the at least one luminaire transceiver over at least one of a Bluetooth®, WiFi®, near field communication (NFC), ANT®, or IEEE 802.15 channel.

4. The method of claim 1 wherein receiving MLPS location information from an MLPS over the at least one data communications channel comprises receiving MLPS location information by the at least one luminaire transceiver over at least one of a short-range wireless channel or a wired communications channel.

5. The method of claim 1 wherein sending the luminaire location information and the luminaire identification information to the asset management system over the at least one data communications channel comprises sending the luminaire location information and the luminaire identification information to the asset management system through at least one wireless communications channel.

6. The method of claim 1 wherein sending the luminaire location information and the luminaire identification information to the asset management system over the at least one data communications channel comprises sending the luminaire location information and the luminaire identification information to the asset management system through at least one power-line power distribution system.

7. The method of claim 1, further comprising:
receiving, by at least one luminaire transceiver of the luminaire, the luminaire identification information from an MLPS over the at least one data communications channel.

8. The method of claim 7 wherein receiving the luminaire identification information from an MLPS over the at least one data communications channel comprises receiving the luminaire identification information by the at least one luminaire transceiver over at least one of a Bluetooth®, WiFi®, near field communication (NFC), ANT®, or IEEE 802.15 channel.

9. The method of claim 7 wherein receiving the luminaire identification information from an MLPS over the at least one data communications channel comprises receiving the luminaire identification information by at least one of a short-range wireless channel or a wired communications channel.

10. A luminaire, comprising:
at least one luminaire processor;
at least one luminaire transceiver operatively coupled to the at least one luminaire processor and to at least one data communications channel; and
at least one luminaire nontransitory processor-readable storage medium operatively coupled to the at least one luminaire processor and which stores luminaire identification information which uniquely identifies the luminaire, the at least one luminaire nontransitory processor-readable storage medium further storing at least one of data or instructions which, when executed by the at least one luminaire processor, cause the at least one luminaire processor to:
receive, via the at least one luminaire transceiver, mobile location provider system (MLPS) location information from an MLPS over the at least one data communications channel, the MLPS location information indicative of a geographical location of the MLPS when the MLPS is positioned proximate the luminaire;
store the received MLPS location information in the at least one nontransitory processor-readable storage medium as luminaire location information for the luminaire, the luminaire location information indicative of a geographical location of the luminaire; and
send, via the at least one luminaire transceiver, the luminaire identification information and the luminaire location information to an asset management system over the at least one data communications channel.

11. The luminaire of claim 10 wherein the at least one luminaire processor:
receives MLPS location information from an MLPS, the MLPS location information indicative of a geographical location of the MLPS when the MLPS is positioned within 50 feet of the luminaire.

12. The luminaire of claim 10 wherein the at least one luminaire transceiver receives the MLPS location information from the MLPS over at least one of a Bluetooth®, WiFi®, near field communication (NFC), ANT®, or IEEE 802.15 channel.

13. The luminaire of claim 10 wherein the at least one luminaire transceiver receives the MLPS location information from the MLPS over at least one of a short-range wireless channel or a wired communications channel.

14. The luminaire of claim 10 wherein the at least one luminaire transceiver sends the luminaire location information to the asset management system through at least one wireless communications channel.

15. The luminaire of claim 10 wherein the at least one luminaire transceiver sends the luminaire location information to the asset management system through at least one power-line power distribution system.

16. The luminaire of claim 10 wherein the at least one luminaire processor:
receives, via the at least one luminaire transceiver, the luminaire identification information from an MLPS over the at least one data communications channel.

17. The luminaire of claim 16 wherein the at least one luminaire transceiver receives the luminaire identification information from an MLPS over at least one of a Bluetooth®, WiFi®, near field communication (NFC), ANT®, or IEEE 802.15 channel.

18. The luminaire of claim 16 wherein the at least one luminaire transceiver receives the luminaire identification information from an MLPS over at least one of a short-range wireless channel or a wired communications channel.

19. A method of operation for a processor-based system to manage a plurality of remotely located luminaires, the method comprising:
receiving, by at least one asset management processor, luminaire information from a plurality of luminaires over at least one data communications channel, wherein, for each of the luminaires, the luminaire information includes at least luminaire identification information that uniquely identifies the luminaire and luminaire location information that identifies a geographical location of the luminaire, the luminaire location information received by the luminaire over at least one data communications channel from a mobile location provider system (MLPS) as MLPS location information for the MLPS, the MLPS location information indicative of a geographical location of the MLPS when the MLPS is positioned proximate the luminaire;
storing, by the at least one asset management processor, the received luminaire information in a nontransitory processor-readable storage medium;
autonomously generating, by the at least one asset management processor, an electronic report based at least in part on the received luminaire information; and
causing, by the at least one asset management processor, a user interface of a processor-based device to present the electronic report to a user.

20. The method of claim 19 wherein autonomously generating an electronic report comprises autonomously generating an electronic report that includes a map of the plurality of luminaires.

21. The method of claim 19 wherein autonomously generating an electronic report comprises autonomously generating a spreadsheet that includes the luminaire identification information and the luminaire location information for each of the plurality of luminaires.

22. The method of claim 19 wherein causing, by the at least one asset management processor, a user interface of a processor-based device to present the electronic report to a user comprises sending the electronic report to a processor-based device associated with the user over the at least one data communications channel.

23. The method of claim 19 wherein receiving luminaire information from a plurality of luminaires over at least one data communications channel comprises receiving luminaire information from the plurality of luminaires through at least one wireless communications channel.

24. The method of claim 19 wherein receiving luminaire information from a plurality of luminaires over at least one data communications channel comprises receiving luminaire information from the plurality of luminaires through at least one power-line power distribution system.

25. The method of claim 24 wherein receiving luminaire information from the plurality of luminaires through at least one power-line power distribution system comprises decoding the luminaire information from a power line of the power-line power distribution system.

26. A luminaire management system, comprising:
at least one asset management system comprising:
at least one asset management processor;
at least one asset management system transceiver operatively coupled to the at least one asset management processor and a data communications channel; and
at least one nontransitory processor-readable storage medium operatively coupled to the at least one asset management processor and storing at least one of data or instructions which, when executed by the at least one asset management processor, cause the at least one asset management processor to:
receive luminaire information from a plurality of luminaires over the at least one data communications channel, wherein, for each of the luminaires, the luminaire information includes at least luminaire identification information that uniquely identifies the luminaire and luminaire location information that identifies a geographical location of the luminaire, the luminaire location information received by the luminaire over at least one data communications channel from a mobile location provider system (MLPS) as MLPS location information for the MLPS, the MLPS location information indicative of a geographical location of the MLPS when the MLPS is positioned proximate the luminaire;
store the received luminaire information in the at least one nontransitory processor-readable storage medium;
autonomously generate an electronic report based at least in part on the received luminaire information; and
cause a user interface of a processor-based device to present the electronic report to a user.

27. The luminaire management system of claim 26 wherein the at least one asset management processor:
autonomously generates an electronic report that includes a map of the plurality of luminaires.

28. The luminaire management system of claim 26 wherein the at least one asset management processor:
autonomously generates a spreadsheet that includes the luminaire identification information and the luminaire location information for each of the plurality of luminaires.

29. The luminaire management system of claim 26 wherein the at least one asset management processor:
sends the electronic report to a processor-based device associated with the user over the at least one data communications channel.

30. The luminaire management system of claim 26 wherein the at least one data communications channel includes at least one wireless communications channel.

31. The luminaire management system of claim 26 wherein the at least one data communications channel includes at least one power-line power distribution system.

32. A method to provide a luminaire with luminaire information, the method comprising:
positioning a mobile location provider system (MLPS) proximate the luminaire, the MLPS storing MLPS location information on a nontransitory processor-readable storage medium of the MLPS, the MLPS location information indicative of a geographical location of the MLPS when the MLPS is positioned proximate the luminaire; and
sending, by the MLPS, the MLPS location information to the luminaire over at least one data communications channel for storage as luminaire location information for the luminaire on a nontransitory processor-readable storage medium of the luminaire, the luminaire location information indicative of a geographical location of the luminaire.

33. The method of claim 32 wherein the luminaire is one luminaire in an illumination system comprising a plurality of luminaires, and positioning an MLPS proximate the luminaire comprises positioning an MLPS a distance from the luminaire less than distances from respective other ones of the plurality of luminaires in the illumination system.

34. The method of claim 32 wherein sending the MLPS location information to the luminaire comprises:
sending a current location of the MLPS to the luminaire over the at least one data communications channel.

35. The method of claim 32 wherein sending the MLPS location information to the luminaire comprises:
sending a previous location of the MLPS to the luminaire over the at least one data communications channel.

36. The method of claim 32 wherein sending the MLPS location information comprises sending GPS data provided by a GPS receiver associated with the MLPS to the luminaire.

37. The method of claim 32 wherein sending the MLPS location information to the luminaire comprises sending the MLPS location information to the luminaire over a short-range wireless communications channel or a wired communications channel.

38. The method of claim 32 wherein sending the MLPS location information to the luminaire comprises sending the MLPS location information to the luminaire over at least one of a Bluetooth®, WiFi®, near field communication (NFC), ANT®, or IEEE 802.15 channel.

39. The method of claim 32 wherein sending the MLPS location information to the luminaire comprises sending the MLPS location information to the luminaire via at least one of a smartphone, tablet computer, or notebook computer.

40. A mobile location provider system (MLPS) to provide luminaire information to a luminaire, the luminaire comprising at least one luminaire processor, at least one luminaire transceiver operatively coupled to the at least one luminaire processor and operatively coupled to at least one data communications channel, and at least one luminaire nontransitory processor-readable storage medium operatively coupled to the at least one luminaire processor, the MLPS comprising:
at least one MLPS processor;
at least one MLPS transceiver operatively coupled to the at least one MLPS processor and to at least one data communications channel; and
at least one MLPS nontransitory processor-readable storage medium operatively coupled to the at least one MLPS processor and storing MLPS location information indicative of a geographical location of the MLPS when the MLPS is positioned proximate the luminaire, the at least one MLPS nontransitory processor-readable storage medium further storing at least one of data or instructions which, when executed by the at least one MLPS processor, cause the at least one MLPS processor to:
send, via the at least one MLPS transceiver, the MLPS location information to the luminaire over the at least one data communications channel for storage as luminaire location information on the at least one luminaire nontransitory processor-readable storage medium, the luminaire location information indicative of a geographical location of the luminaire.

41. The MLPS of claim 40 wherein the at least one MLPS processor:
sends a current MLPS location information to the luminaire over the at least one data communications channel when the MLPS is positioned proximate the luminaire.

42. The MLPS of claim 40 wherein the at least one MLPS processor:
sends a previous MLPS location information to the luminaire over the at least one data communications channel.

43. The MLPS of claim 40, further comprising:
a global positioning system (GPS) receiver operatively coupled to the at least one MLPS processor;
wherein the MLPS processor sends GPS data provided by the GPS receiver to the luminaire over the at least one data communications channel.

44. The MLPS of claim 40 wherein the MLPS processor:
sends a current location of the MLPS to the luminaire over at least one of a short-range wireless communications channel or a wired communications channel.

45. The MLPS of claim 44 wherein the short-range wireless communications channel comprises at least one of a Bluetooth®, WiFi®, near field communication (NFC), ANT®, or IEEE 802.15 channel.

46. The MLPS of claim 40 wherein the MLPS comprises at least one of a smartphone, a tablet computer, or a notebook computer.

47. A method of operation to manage a plurality of remotely located luminaires in an illumination system, the method comprising:
for each of the plurality of luminaires,
positioning a mobile location provider system (MLPS) proximate the luminaire, the MLPS storing MLPS location information indicative of a geographical location of the MLPS when the MLPS is positioned proximate the luminaire;
sending, by the MLPS, the MLPS location information to the luminaire over at least one data communications channel;
storing, by at least one luminaire processor of the luminaire, the MLPS location information as luminaire location information for the luminaire in a nontransitory processor-readable storage medium, the luminaire location information indicative of a geographical location of the luminaire; and
sending, by at least one luminaire transceiver of the luminaire, the luminaire location information to at least one asset management processor of an asset management system over the at least one data communications channel.

48. The method of claim 47 wherein the luminaire is one luminaire in an illumination system comprising a plurality of luminaires, and positioning an MLPS proximate the luminaire comprises positioning an MLPS a distance from the luminaire less than distances from respective other ones of the plurality of luminaires in the illumination system.

49. The method of claim 47 wherein sending the luminaire location information comprises sending the luminaire location information through at least one wireless communications channel.

50. The method of claim 47 wherein sending the luminaire location information comprises sending the luminaire location information through at least one power-line power distribution system.

51. The method of claim 47, further comprising:
autonomously generating, by at the least one asset management processor, an electronic report based at least in part on the luminaire location information; and
causing, by the at least one asset management processor, a user interface of a processor-based device to present the electronic report to a user.

52. The method of claim 51 wherein autonomously generating an electronic report comprises autonomously generating an electronic report that includes a map of the plurality of luminaires.

53. The method of claim 51 wherein autonomously generating an electronic report comprises autonomously generating a spreadsheet that includes the luminaire location information for each of the plurality of luminaires.

54. The method of claim 51 wherein causing, by the at least one asset management processor, a user interface of a processor-based device to present the electronic report to a user comprises sending the electronic report to a processor-based device associated with the user over the at least one data communications channel.

55. The method of claim 47 wherein positioning the MLPS proximate the luminaire comprises positioning the MLPS proximate the luminaire, the MLPS including a global positioning system (GPS) receiver, and sending the MLPS location information to the luminaire comprises sending GPS data provided by the GPS receiver to the luminaire.

56. The method of claim 47 wherein sending the MLPS location information to the luminaire comprises sending a current location of the MLPS to the luminaire over a short-range wireless communications channel.

57. The method of claim 56 wherein sending the MLPS location information to the luminaire over a short-range wireless communications channel comprises sending the current location of the MLPS to the luminaire over at least one of a Bluetooth®, WiFi®, near field communication (NFC), ANT®, or IEEE 802.15 channel.

58. The method of claim 47 wherein sending the MLPS location information to the luminaire comprises sending MLPS location information to the luminaire via at least one of a smartphone, tablet computer, or notebook computer.
